(19) United States
(12) Patent Application Publication
(10) Pub. No.: US 2011/0026819 A1
(43) Pub. Date: Feb. 3, 2011

(54) Apparatus, method, and medium of encoding and decoding image data using sampling

(75) Inventors: Sang Jo Lee, Suwon-si (KR); Shi Hwa Lee, Seoul (KR); Ho Jin Lee, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/656,063

(22) Filed: Jan. 14, 2010

(30) Foreign Application Priority Data
Jul. 28, 2009 (KR) 10-2009-0068965

(51) Int. Cl. G06K 9/36

(52) U.S. Cl. 382/166; 382/232

(57) ABSTRACT

An image data encoding/decoding apparatus and method using sampling is provided. The image data encoding apparatus may compress image data, pre-processed for each block, after sampling or without sampling, and select a more efficient compression mode from results of the compressing. The image data decoding apparatus may determine a decompression mode corresponding to the selected compression mode, and up-sample the image data after decompressing the image data based on a decompression mode, or decompress the image data without sampling, to provide high definition regardless of a type of image data.

### CROSS-REFERENCE TO RELATED APPLICATIONS

This application claims the benefit of Korean Patent Application No. 10-2009-0068965, filed on Jul. 28, 2009, in the Korean Intellectual Property Office, the disclosure of which is incorporated herein by reference.

### BACKGROUND

1. Field

Example embodiments relate to an apparatus and method of encoding and decoding image data, and more particularly, to an apparatus and method of encoding and decoding image data using sampling and non-sampling.

2. Description of the Related Art

Currently, a large amount of image data is required to provide a high definition image due to the development of video technologies. Although a large amount of image data may enable a high definition image, the large amount of image data may also cause a significant load.

Accordingly, a method for efficiently compressing image data is desired. However, various types of image data may exist and thus, depending on an applied compression method, an image quality may be degraded, and a compression efficiency may be reduced. For example, when a same compression method is applied to a general image such as a natural image and a synthesized image such as a pattern image, compression efficiency may be reduced.

Thus, a method that can efficiently compress an image and maintain a high image quality regardless of a type of image data is required.

### SUMMARY

Additional aspects and/or advantages will be set forth in part in the description which follows and, in part, will be apparent from the description, or may be learned by practice of the disclosure.

According to example embodiments, there may be provided an image data encoding apparatus, including: a pre-processing unit to pre-process image data for each block; a down-sampling unit to down-sample the pre-processed image data; a first compression unit to compress the down-sampled image data based on a first compression mode; a second compression unit to compress the pre-processed image data based on a second compression mode; and a mode selection unit to select a compression mode to be applied to the image data, using results of performing the first compression mode and the second compression mode.

According to example embodiments, there may be provided an image data decoding apparatus, including: a mode determination unit to determine a decompression mode with respect to compressed image data; a first decompression unit to decompress the image data based on a first decompression mode, when the first decompression mode is determined as the decompression mode; an up-sampling unit to up-sample the image data decompressed based on the first decompression mode; and a second decompression unit to decompress the image data based on a second decompression mode, when the second decompression mode is determined as the decompression mode.

According to example embodiments, there may be provided an image data encoding method, including: pre-processing image data for each block; down-sampling the pre-processed image data; compressing the down-sampled image data based on a first compression mode; compressing the pre-processed image data based on a second compression mode; and selecting a compression mode to be applied to the image data, using results of performing the first compression mode and the second compression mode.

According to example embodiments, there may be provided an image data decoding method, including: determining a decompression mode with respect to compressed image data; decompressing the image data based on a first decompression mode, when the first decompression mode is determined as the decompression mode; up-sampling the image data decompressed based on the first decompression mode; and decompressing the image data based on a second decompression mode, when the second decompression mode is determined as the decompression mode.

Additional aspects of the example embodiments will be set forth in part in the description which follows and, in part, will be apparent from the description, or may be learned by practice of the embodiments.

### BRIEF DESCRIPTION OF THE DRAWINGS

These and/or other aspects will become apparent and more readily appreciated from the following description of the example embodiments, taken in conjunction with the accompanying drawings of which:

FIG. 1 illustrates an example of encoding and decoding image data using sampling according to example embodiments;

FIG. 2 illustrates a block diagram of the image data encoding apparatus of FIG. 1;

FIG. 3 illustrates a block diagram of the image data decoding apparatus of FIG. 1;

FIG. 4 illustrates an example of pre-processing image data for each block according to example embodiments;

FIG. 5 illustrates an example of down-sampling image data according to example embodiments;

FIG. 6 illustrates an example of compressing image data based on a Pulse Coded Modulation (PCM)-based compression mode according to example embodiments;

FIG. 7 illustrates an example of decompressing image data based on a PCM-based decompression mode according to example embodiments;

FIG. 8 illustrates an example of compressing and decompressing image data based on a binary-based compression and decompression mode according to example embodiments;

FIG. 9 illustrates an example of up-sampling decompressed image data according to example embodiments;

FIG. 10 illustrates a flowchart of an image data encoding method according to example embodiments; and

FIG. 11 illustrates a flowchart of an image data decoding method according to example embodiments.

### DETAILED DESCRIPTION

Reference will now be made in detail to example embodiments, examples of which are illustrated in the accompanying drawings, wherein like reference numerals refer to the like elements throughout. Example embodiments are described below to explain the present disclosure by referring to the figures.

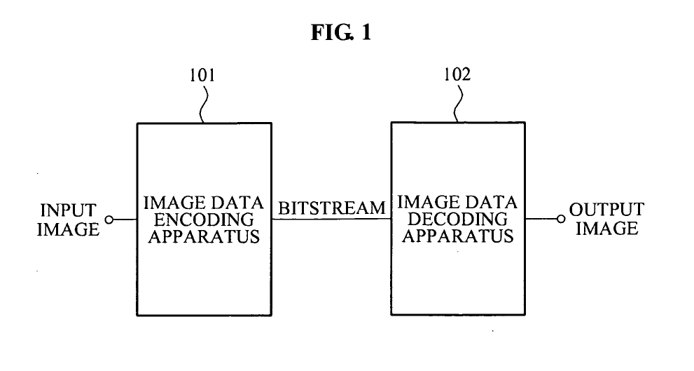

FIG. 1 illustrates an example of encoding and decoding image data using sampling according to example embodiments.

Referring to FIG. 1, an image data encoding apparatus 101 to compress input image data and an image data decoding apparatus 102 to decompress the compressed image data are illustrated. The image data encoding apparatus 101 may compress the input image data using sampling and non-sampling. In this instance, the image data encoding apparatus 101 may compress the image data after down-sampling or without down-sampling. Subsequently, the image data encoding apparatus 101 may select a more efficient mode from among the two compression modes.

The compressed image data may be transmitted to the image data decoding apparatus 102 through a bitstream. In this instance, the bitstream may include a mode bit indicating the compression mode selected by the image data encoding apparatus 101.

Also, the image data decoding apparatus 102 may determine a decompression mode with respect to the image data transmitted through the bitstream. Subsequently, the image data decoding apparatus 102 may decompress the compressed image data based on the determined decompression mode. The image data decoding apparatus 102 may perform up-sampling after decompressing the image data which is compressed after down-sampling.

Accordingly, the image data encoding apparatus 101 and the image data decoding apparatus 102 may use modes using sampling and non-sampling, and thereby may provide high definition coding regardless of a type of image data.

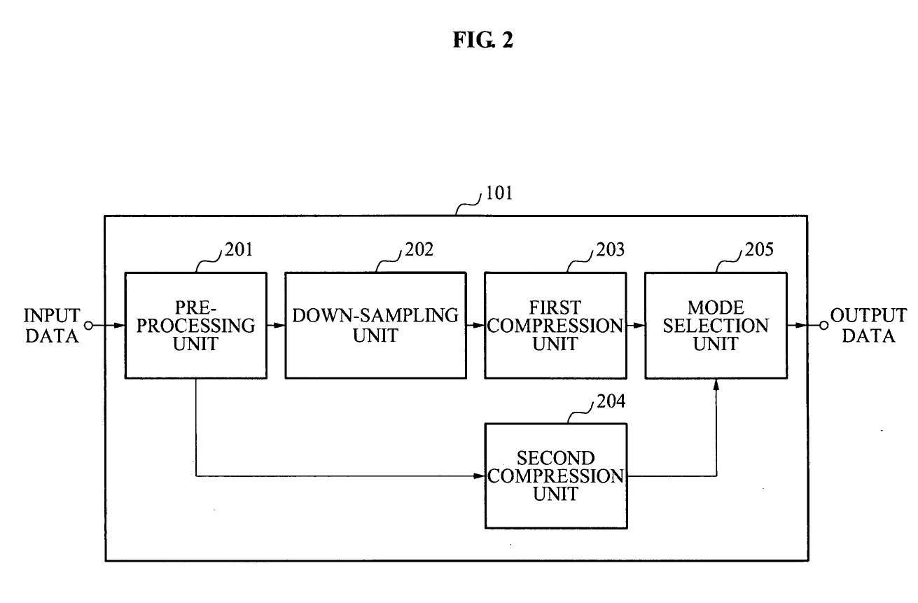

FIG. 2 illustrates a block diagram of the image data encoding apparatus 101 of FIG. 1.

Referring to FIG. 2, the image data encoding apparatus 101 may include a pre-processing unit 201, a down-sampling unit 202, a first compression unit 203, a second compression unit 204, and a mode selection unit 205.

The pre-processing unit 201 may pre-process input image data for each block. For example, the pre-processing unit 201 may divide the image data into a plurality of blocks.

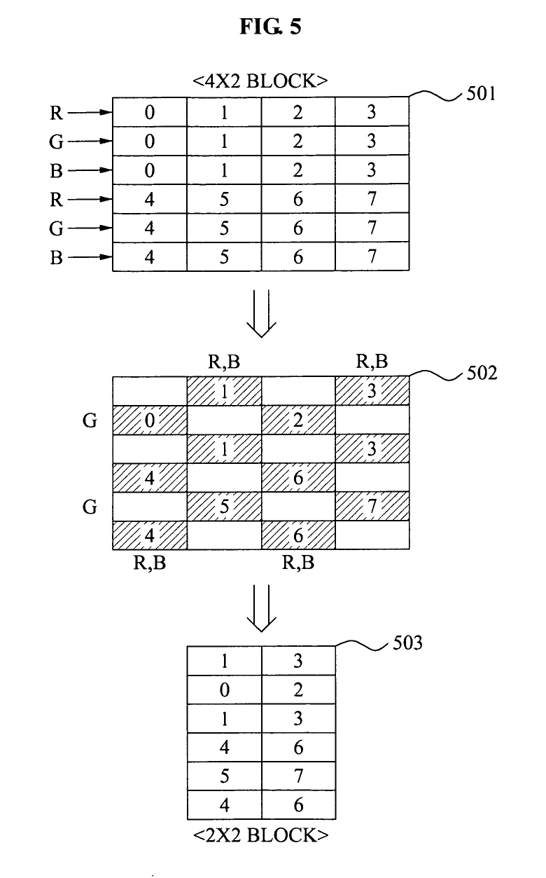

The down-sampling unit 202 may down-sample the pre-processed image data. In this instance, the down-sampling unit 202 may down-sample the image data for each color included in each of the plurality of blocks, and thereby may sample a size of each of the blocks into half. For example, the image data may be Red Green Blue (RGB) image data. In this instance, the down-sampling unit 202 may down-sample the image data by varying positions of G and R, B during sampling. An operation of down-sampling is described in greater detail with reference to FIG. 5.

The first compression unit 203 may compress the down-sampled image data. That is, the first compression unit 203 may compress the down-sampled image data based on a first compression mode. For example, the first compression unit 203 may compress the down-sampled image data based on an existing image compression mode such as a Joint Photographic Experts Group (JPEG) scheme.

The second compression unit 204 may compress the image data, pre-processed by the pre-processing unit 201, based on a second compression mode. That is, the second compression unit 204 may compress the image data which is not down-sampled. For example, the second compression unit 204 may compress non-down-sampled image data based on the existing image compression mode such as the JPEG scheme. Also, the second compression unit 204 may compress non-down-sampled image data based on a Pulse Coded Modulation (PCM)-based compression mode. Also, the second compression unit 204 may compress non-down-sampled image data based on a binary-based compression mode. For another example, the second compression unit 204 may compress non-down-sampled image data by combining at least two of the existing image compression mode, the PCM-based compression mode, and the binary-based compression mode.

For example, the first compression mode may be more likely to be applied than the second compression mode as a pixel-by-pixel correlation of the image data increases. That is, image data with a high pixel-by-pixel correlation may be efficiently decompressed through surrounding pixels, even though the image data is additionally compressed through down-sampling. Accordingly, the image data with the high pixel-by-pixel correlation, such as a natural image, may be additionally compressed through down-sampling, and thus a high efficiency image compression may be performed and an original image quality may be maintained. Also, image data with a low pixel-by-pixel correlation such as a pattern image and a random image may be compressed without down-sampling.

The mode selection unit 205 may select a compression mode to be applied to the image data, using results of performing the first compression mode and the second compression mode. That is, the mode selection unit 205 may select a more efficient compression mode from among the compression modes used for the image data, compressed based on the first compression mode after down-sampling, and used for the image data compressed based on the second compression mode without down-sampling. For example, the mode selection unit 205 may select a compression mode, which has a smaller error value or has a smaller quantity of allocation bits, based on the results of the first compression mode and the second compression mode. The selected compression mode may be represented as a mode bit in a bitstream.

In this instance, the error value may be determined according to Equation 1 and Equation 2.

$$\begin{matrix}SAD ( Sum of Absolute Difference ) = {\sum }_{k = 0}^{N - 1} \vert {Error}_{k} \vert & Equation 1 \\ MAX Diff = Max ( {Error}_{0} , {Error}_{1} , … … , {Error}_{N - 1} ) & Equation 2\end{matrix}$$

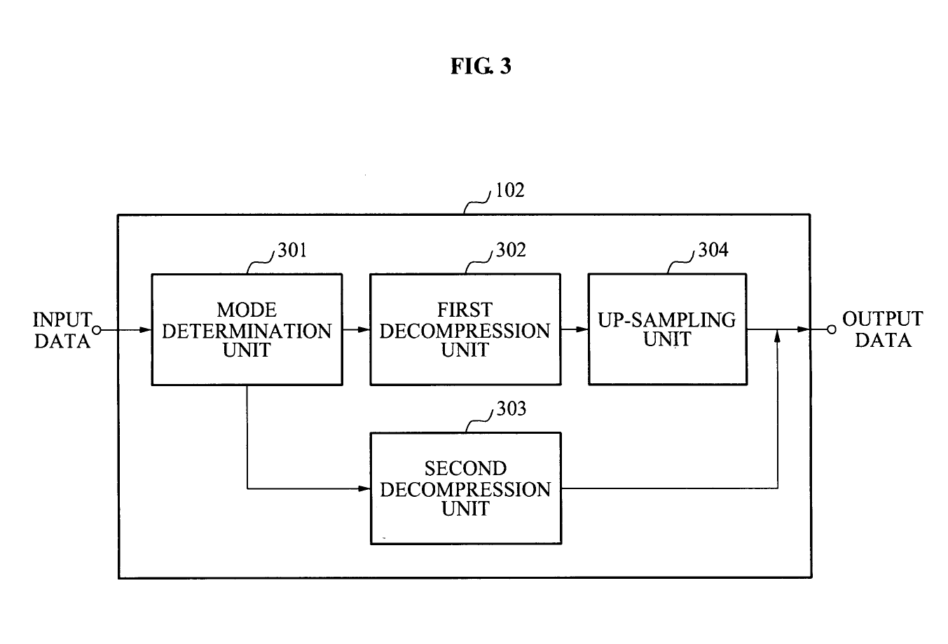

FIG. 3 illustrates a block diagram of the image data decoding apparatus 102 of FIG. 1.

Referring to FIG. 3, the image data decoding apparatus 102 may include a mode determination unit 301, a first decompression unit 302, a second decompression unit 303, and an up-sampling unit 304.

The mode determination unit 301 may determine a decompression mode with respect to compressed image data. In this instance, the decompression mode may correspond to a compression mode selected by the image data encoding apparatus 101. Also, the compression mode may be represented as a mode bit in a bitstream.

The first decompression unit 302 may decompress the image data based on a first decompression mode, when the first decompression mode is determined as the decompression mode, e.g., by the mode determination unit 301. In this instance, the first decompression mode may be applied to the compressed image data based on the first compression mode after down-sampling. For example, the first decompression unit 302 may decompress the image data based on an existing image decompression mode such as the JPEG scheme.

The second decompression unit 303 may decompress the image data based on a second decompression mode, when the second decompression mode is determined as the decompression mode, e.g., by the mode determination unit 301. In this instance, the second decompression mode may be applied to the image data which is compressed based on the second compression mode without down-sampling. The first compression mode is more likely to be applied than the second decompression mode as a pixel-by-pixel correlation of the image data increases.

For example, the second decompression unit 303 may decompress non-down-sampled image data based on an existing image decompression mode such as a JPEG scheme. Also, the second decompression unit 303 may decompress non-down-sampled image data based on a PCM-based decompression mode. In addition, the second decompression unit 303 may decompress non-down-sampled image data based on a binary-based decompression mode. For another example, the second decompression unit 303 may decompress non-down-sampled image data by combining at least two of the existing image decompression modes, e.g., the PCM-based decompression mode, and the binary-based decompression mode.

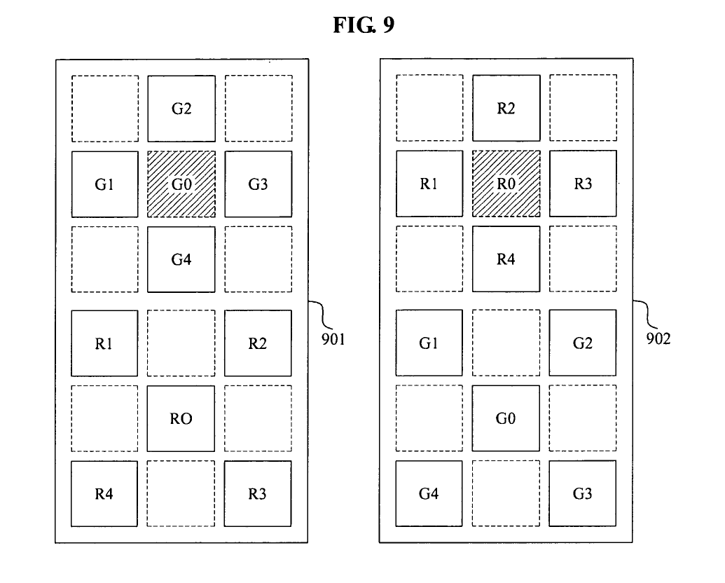

The up-sampling unit 304 may up-sample the image data decompressed based on the first decompression mode. That is, since the first decompression mode is applied to the down-sampled image data, the up-sampling unit 304 may up-sample the image data depending on a result of the down-sampling. For example, the up-sampling unit 304 may up-sample the image data decompressed based on the first decompression mode. The up-sampling unit 304 may up-sample a first color located at a current position using an average value of a first color located around the current position and a correlation between a second color located at the current position of the first color and a second color located around the current position of the first color. An up-sampling operation is described in greater detail with reference to FIG. 9.

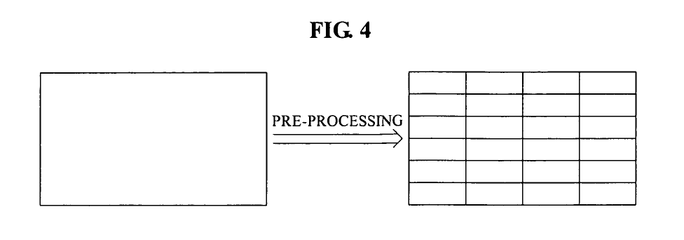

FIG. 4 illustrates an example of pre-processing image data for each block according to example embodiments.

The pre-processing unit 201 may pre-process image data for each block. Specifically, the pre-processing unit 201 may divide the image data into a plurality of blocks. In this instance, a width of each of the plurality of blocks may be twice as wide as a height of each of the plurality of blocks due to down-sampling. For example, a size of the divided block may be 4*2, 8*4, 16*8, and 32*16.

Subsequently, when the image data is down-sampled, the width may be equal to the height. For example, when the image data is divided into blocks of 4*2, 8*4, 16*8, or 32*16 through the pre-processing, the image data may become blocks of 2*2, 4*4, 8*8, and 16*16, respectively, after down-sampling.

FIG. 5 illustrates an example of down-sampling image data according to example embodiments.

A block 501 of 4*2 of image data, which is pre-processed for each block, is illustrated in FIG. 5. In this instance, the block 501 may include R, G, and B colors. The down-sampling unit 202 may down-sample the pre-processed image data. Here, the down-sampling may indicate compressing the image data at a predetermined rate, and may be performed with respect to a predetermined color of the block 501.

For example, the down-sampling unit 202 may down-sample the image data based on a sampling position and a sampling cycle. In this instance, the down-sampling unit 202 may determine sampling positions of G and R or B to be different from each other. Specifically, the down-sampling unit 202 may perform sampling in a Quincunx pattern. For example, as illustrated in a block 502, when the down-sampling unit 202 samples G at positions of 0, 2, 5, and 7, the down-sampling unit 202 may sample R and B at positions of 1, 3, 4, and 6. Conversely, the down-sampling unit 202 may sample G at positions of 1, 3, 4, and 6, and sample R and B at positions of 0, 2, 5, and 7.

Also, the down-sampling unit 202 may sample the image data with a sampling cycle of one line for every two lines for each color. For example, when sampling G of line 0 in the block 501, the down-sampling unit 202 may sample a single R and B of line 1 in the block 501. Also, when sampling G of line 2 in the block 501, the down-sampling unit 202 may sample a single R and B of line 3 in the block 501. Conversely, when sampling a single R and B of line 0 in the block 501, the down-sampling unit 202 may sample G of line 1. That is, the down-sampling unit 202 may perform sampling without overlapping of sampling positions for each color in the block 501.

The down-sampling unit 202 may finally extract a down-sampled block 503 from the block 502. When the down-sampling unit 202 down-samples a block having a width of M and a height of N, a block having a width of M/2 and a height of N may be outputted. That is, when the down-sampling unit 202 performs ½ down-sampling, the block 503 of 2*2 may be extracted from the block 501 of 4*2. Subsequently, the down-sampling unit 202 may additionally compress the image data by applying an existing image compression mode such as the JPEG scheme to the block 503.

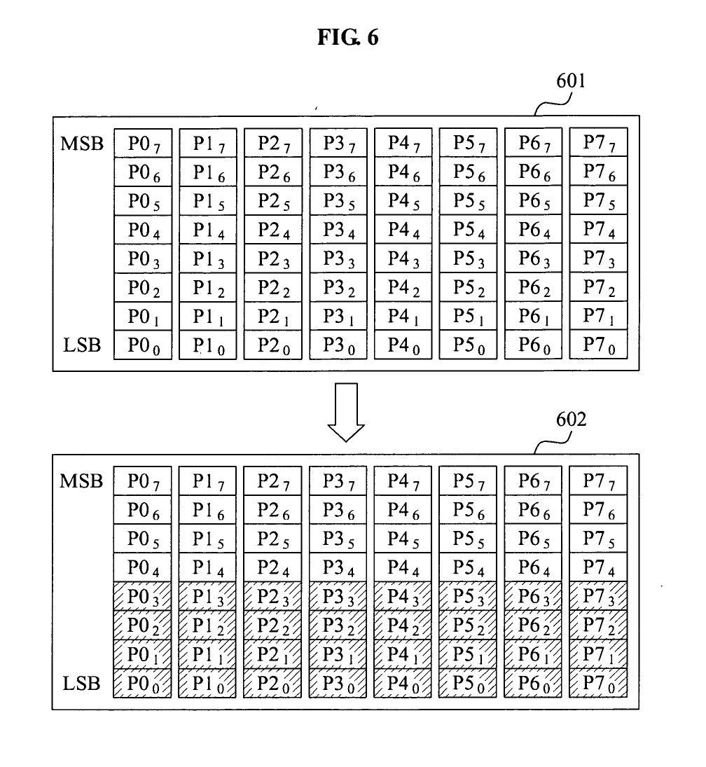

FIG. 6 illustrates an example of compressing image data based on a PCM-based compression mode according to example embodiments.

Referring to FIG. 6, a block 601 may indicate a compression operation based on a lossless PCM-based compression mode, and a block 602 may indicate a compression operation based on a lossy PCM-based compression mode.

That is, the lossless PCM-based compression mode may indicate losslessly compressing the input block 601. The lossy PCM-based compression mode may indicate compressing after excluding a portion of a Least Significant Bit (LSB) of the input block 602. For example, the second compression unit 204 may remove four bits corresponding to an LSB from the block 602 of 4*2 based on the lossy PCM-based compression mode, and thereby may compress the block 602. In this instance, MSB may indicate “Most Significant Bit”. For example, the PCM-based compression mode may be applied when image data with a low pixel-by-pixel correlation such as a pattern image or a random image is compressed.

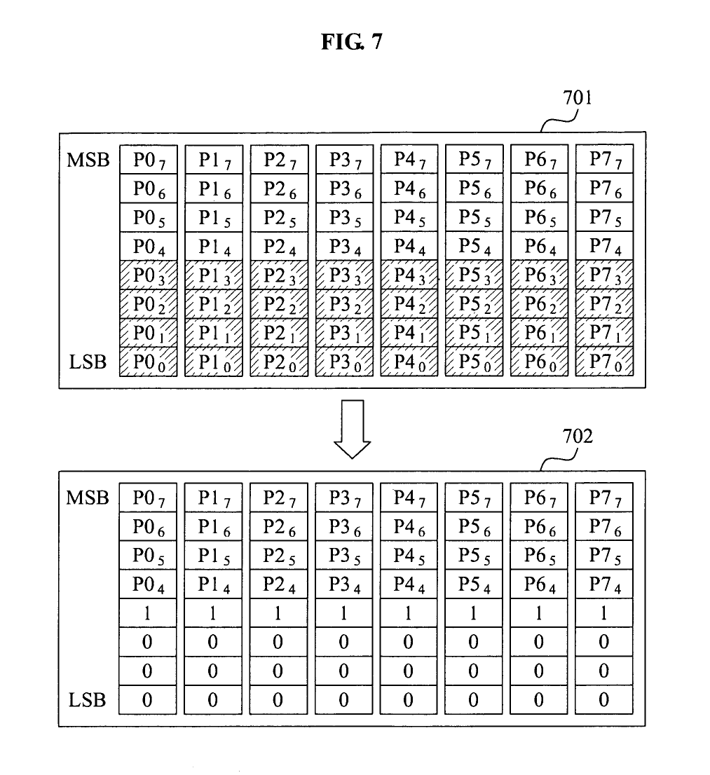

FIG. 7 illustrates an example of decompressing image data based on a PCM-based decompression mode according to example embodiments.

When a block is compressed based on a lossless PCM-based compression mode, the second decompression unit 303 may decompress the block using PCM data of the compressed block based on a lossless PCM-based decompression mode. For example, when PCM data of the compressed block, P0, P1, P2, P3, P4, P5, P6, and P7, is input, the second decompression unit 303 may decompress the block including P0, P1, P2, P3, P4, P5, P6, and P7 as is.

In FIG. 7, a block 701 may indicate a result of compressing based on a lossy PCM-based compression mode, and a block 702 may indicate a result of decompressing based on a lossy PCM-based decompression mode. That is, when the block is compressed based on the lossy PCM-based compression mode, the second decompression unit 303 may decompress the block using PCM data of the compressed block 701 based on the lossy PCM-based decompression mode.

For example, as illustrated in the block 701, the second compression unit 204 may perform compression excluding LSBs of the block 701 based on the lossy PCM-based compression mode. Also, the second decompression unit 303 may decompress a portion of the LSBs to be a predetermined length. That is, when PCM data of the compressed block 701, P0, P1, P2, P3, P4, P5, P6, and P7, is input, the second decompression unit 303 may decompress the block 702 from P0′, P1′, P2′, P3′, P4′, P5′, P6′, and P7′.

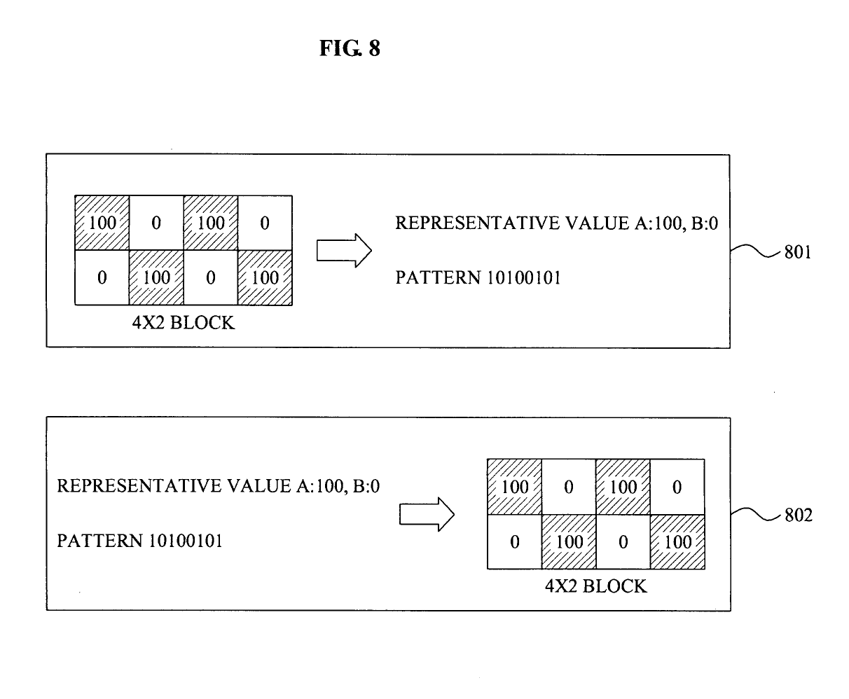

FIG. 8 illustrates an example of compressing and decompressing image data based on a binary-based compression and decompression mode according to example embodiments.

The second compression unit 204 may compress a block based on a binary-based compression mode 801 with respect to image data with a low pixel-by-pixel correlation such as a pattern image or a random image. Also, the second decompression unit 303 may decompress the compressed block based on a binary-based decompression mode 802.

When data included in the block includes two or less pixels, the second compression unit 204 may compress the block based on the binary-based compression mode 801. In this instance, the binary-based compression mode 801 may configure the block including a representative value and a pattern.

As illustrated in FIG. 8, when a 4*2 block forms a pattern using data of 100 and 0, the second compression unit 204 may determine A=100 and B=0 as a representative value. Also, each of the representative values may be set as a binary number of 1 and 0, and thus a pattern of representative values in the 4*2 block may be determined as 10100101.

Accordingly, even when only representative value and pattern of the representative values are input, the second decompression unit 303 may decompress image data based on the binary-based decompression mode 802. That is, when the representative values, A=100 and B=0, and the pattern of 10100101 are input, the second decompression unit 303 may enable the 4*2 block to be decompressed based on the binary-based decompression mode 802.

FIG. 9 illustrates an example of up-sampling decompressed image data according to example embodiments.

When image data with a high pixel-by-pixel correlation such as a natural image is down-sampled and compressed based on a first compression mode, the up-sampling unit 304 may up-sample image data decompressed based on a first decompression mode. That is, since half of the colors of a block may be excluded through down-sampling, the up-sampling unit 304 may decompress the excluded colors using surrounding colors.

FIG. 9 illustrates a G decompression operation 901 and an R decompression operation 902. In this instance, the R decompression operation 902 may be identically applied to a B decompression operation.

For example, the up-sampling unit 304 may up-sample a first color located at a current position using an average value of a first color located around the current position and a correlation between a second color located at the current position of the first color and a second color located around the current position of the first color.

For example, according to the G decompression operation 901, G excluded through down-sampling may be decompressed for example, by the following Equation 3.

G=G_{avg}+(D_{R}+D_{B})*weighting_param1(weighting_param1=0˜1), Equation 3

where G_{avg} may denote an average value of G1 through G4 around G0, which is a decompression position. Also, D_{R} may denote a correlation between R0 and R1 through R4 around R0. Here, R0 may be located in a position corresponding to the decompression position G0. Also, D_{B} may denote a correlation between B0 and B1 through B4 around B0. Here, B0 may be located in a position corresponding to the decompression position G0.

For example, when G0 is decompressed according to Equation 3, G0 may be determined by,

G0=G_{avg}+(ΔR+ΔB)/2+(ΔR+ΔB)/8,

where

G_{avg}=(G1+G2+G3+G4+2)/4,

ΔR=R0−(R1+R2+R3+R4+2)/4, and

ΔB=B0−(B1+B2+B3+B4+2)/4.

In this instance, a constant may vary depending on a configuration of a system.

For example, according to the R decompression operation 902, R excluded through down-sampling may be decompressed according to Equation 4 given as below. The R decompression operation 902 may be identically applied to the B decompression operation.

R=R_{avg}+D_{G}*weighting_param2(weighting_param2=0˜1)

B=B_{avg}+D_{G}*weighting_param2(weighting_param2=0˜1), Equation 4

where R_{avg} may denote an average value of R1 through R4 around R0, which is a decompression position. Also, B_{avg} may denote an average value of B1 through B4 around B0 which is a decompression position. Also, D_{G} may denote a correlation between G0 and G1 through G4 around G0. Here, G0 may be located in a position corresponding to the decompression positions B0 and R0.

For example, when R0 is decompressed according to Equation 4, R0 may be determined by,

R0=R_{avg}+ΔG/2

where

R_{avg}=(R1+R2+R3+R4+2)/4, and

ΔG=G0−(G1+G2+G3+G4+2)/4.

Also, when B0 is decompressed according to Equation 4, B0 may be determined by,

B0=Bavg+ΔG/2

where

Bavg=(B1+B2+B3+B4+2)/4, and

ΔG=G0−(G1+G2+G3+G4+2)/4.

In this instance, a constant may vary depending on a configuration of a system.

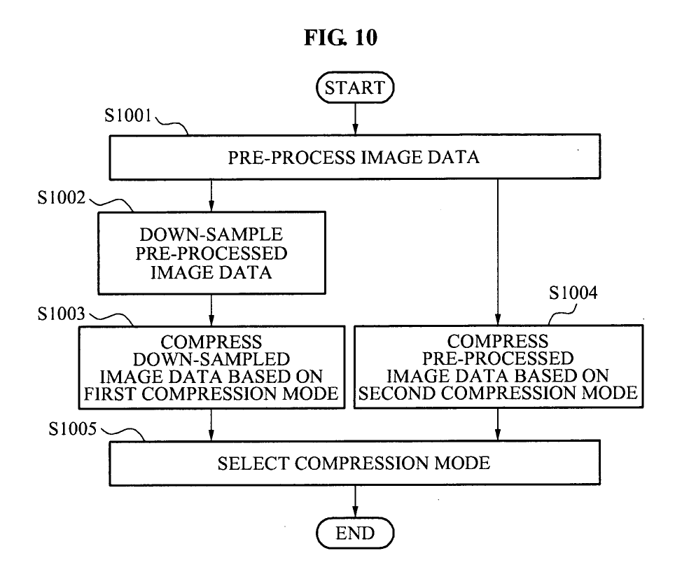

FIG. 10 illustrates a flowchart of an image data encoding method according to example embodiments.

In operation S1001, the image data encoding apparatus 101 may pre-process image data for each block.

In operation S1002, the image data encoding apparatus 101 may down-sample the pre-processed image data. In this instance, the image data may be RGB image data. The image data encoding apparatus 101 may down-sample the image data by varying sampling positions of G and R or B.

In operation S1003, the image data encoding apparatus 101 may compress the down-sampled image data based on a first compression mode. In operation S1004, the image data encoding apparatus 101 may compress the pre-processed image data based on a second compression mode. For example, the first compression mode may be more likely to be applied than the second compression mode as a pixel-by-pixel correlation of the image data increases. That is, the first compression mode may be applied to image data with a high pixel-by-pixel correlation such as a natural image, and the second compression mode may be applied to image data with a low pixel-by-pixel correlation such as a pattern image or a random image.

In this instance, the image data encoding apparatus 101 may compress the down-sampled image data based on an existing image compression mode such as a JPEG scheme. Also, the image data encoding apparatus 101 may compress non-down-sampled image data based on the existing image compression mode such as the JPEG scheme. Also, the image data encoding apparatus 101 may compress non-down-sampled image data based on a PCM-based compression mode. In addition, the image data encoding apparatus 101 may compress non-down-sampled image data based on a binary-based compression mode. As another example, the image data encoding apparatus 101 may compress non-down-sampled image data by combining at least two of the existing image compression modes, the PCM-based compression mode, and the binary-based compression mode.

In operation S1005, the image data encoding apparatus 101 may select a compression mode to be applied to the image data, using results of performing the first compression mode and the second compression mode. For example, the image data encoding apparatus 101 may select a compression mode, which has a smaller error value or has a smaller error value, based on the results of the first compression mode and the second compression mode. The selected compression mode may be represented as a mode bit in a bitstream, and be transmitted to an image data decoding apparatus 102.

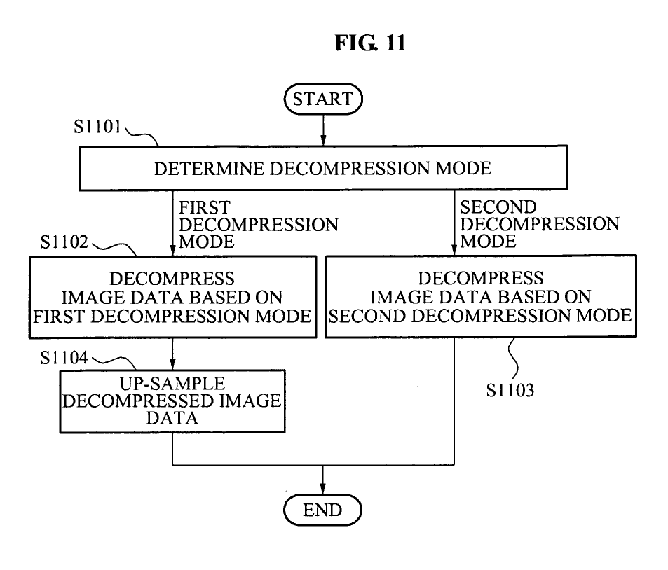

FIG. 11 illustrates a flowchart of an image data decoding method according to example embodiments.

In operation S1101, an image data decoding apparatus 102 may determine a decompression mode with respect to compressed image data. Specifically, the image data decoding apparatus 102 may determine any one of a first decompression mode corresponding to a first compression mode and a second decompression mode corresponding to a second compression mode. That is, the first decompression mode may be applied to image data with a high pixel-by-pixel correlation such as a natural image, and the second decompression mode may be applied to image data with a low pixel-by-pixel correlation such as a pattern image or a random image.

In operation S1102, when the first decompression mode is determined as the decompression mode, the image data decoding apparatus 102 may decompress the image data based on the first decompression mode. For example, the image data decoding apparatus 102 may decompress the compressed image data based on an existing image decompression mode such as a JPEG scheme.

In operation S1104, the image data decoding apparatus 102 may up-sample the image data decompressed based on the first decompression mode. For example, the image data decoding apparatus 102 may up-sample a first color located at a current position using an average value of a first color located around the current position and a correlation between a second color located at the current position of the first color and a second color located around the current position of the first color.

In operation S1103, when the second decompression mode is determined as the decompression mode the image data decoding apparatus 102 may decompress the image data based on the second decompression mode. For example, the image data decoding apparatus 102 may decompress the compressed image data based on the existing image decompression mode such as the JPEG scheme. For example, the image data decoding apparatus 102 may decompress non-down-sampled image data based on a PCM-based decompression mode. Also, the image data decoding apparatus 102 may decompress non-down-sampled image data based on a binary-based decompression mode. For another example, the image data decoding apparatus 102 may decompress compressed image data by combining at least two of the existing image decompression modes, the PCM-based decompression mode, and the binary-based decompression mode.

Descriptions of FIGS. 1 through 9 may be referred to for portions which have not been described with reference to FIGS. 10 and 11.

The image data encoding/decoding method according to the above-described example embodiments may be recorded in computer-readable media including program instructions to implement various operations embodied by a computer. The media may also include, alone or in combination with the program instructions, data files, data structures, and the like.

Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter.

The described hardware devices may be configured to act as one or more software modules in order to perform the operations of the above-described example embodiments, or vice versa. The image data encoding method may be executed on a general purpose computer or processor or may be executed on a particular machine such as the image data encoding apparatus described herein. Similarly, the image data decoding method may be executed on a general purpose computer or processor or may be executed on a particular machine such as the image data decoding apparatus described herein.

Although a few example embodiments have been shown and described, it would be appreciated by those skilled in the art that changes may be made in these example embodiments without departing from the principles and spirit of the disclosure, the scope of which is defined in the claims and their equivalents.

What is claimed is:

1. An image data encoding apparatus, comprising:
a pre-processing unit to pre-process image data for each block and to output pre-processed image data;
a down-sampling unit, controlled by a processor, to down-sample the pre-processed image data;
a first compression unit to compress the down-sampled image data based on a first compression mode to output down-sampled image data;
a second compression unit to compress the pre-processed image data based on a second compression mode; and
a mode selection unit to select a compression mode to be applied to the image data, using results of performing the first compression mode and the second compression mode.

2. The image data encoding apparatus of claim 1, wherein the image data includes Red Green Blue (RGB) image data, and the down-sampling unit down-samples the image data by varying positions of G and R or B during sampling.

3. The image data encoding apparatus of claim 1, wherein the first compression mode is more likely to be applied than the second compression mode as a pixel-by-pixel correlation of the image data increases.

4. The image data encoding apparatus of claim 3, wherein the second compression unit compresses the pre-processed image data based on the second compression mode which is any one of a Pulse Coded Modulation (PCM)-based compression mode and a binary-based compression mode.

5. The image data encoding apparatus of claim 1, wherein the mode selection unit selects a compression mode that has smaller allocation bits or has a smaller error value, based on the results of the first compression mode and the second compression mode.

6. An image data decoding apparatus, comprising:
a mode determination unit to determine a decompression mode with respect to compressed image data;
a first decompression unit to decompress the image data based on a first decompression mode, when the first decompression mode is determined as the decompression mode;
an up-sampling unit, controlled by a processor, to up-sample the image data decompressed based on the first decompression mode; and
a second decompression unit to decompress the image data based on a second decompression mode, when the second decompression mode is determined as the decompression mode.

7. The image data decoding apparatus of claim 6, wherein the mode determination unit determines the decompression mode using a mode bit included in a bitstream with respect to the compressed image data.

8. The image data decoding apparatus of claim 6, wherein the first decompression mode is more likely to be applied than the second decompression mode as a pixel-by-pixel correlation of the image data increases.

9. The image data decoding apparatus of claim 8, wherein the second decompression unit decompresses the compressed image data based on the second decompression mode which is any one of a PCM-based decompression mode and a binary-based decompression mode.

10. The image data decoding apparatus of claim 6, wherein the up-sampling unit up-samples a first color located at a current position using an average value of a first color located around the current position and a correlation between a second color located at the current position of the first color and a second color located around the current position of the first color.

11. An image data encoding method, comprising:
pre-processing image data for each block and outputting pre-processed image data;
down-sampling, by way of a processor, the pre-processed image data;
compressing the down-sampled image data based on a first compression mode and outputting down-sampled image data;
compressing the pre-processed image data based on a second compression mode; and
selecting a compression mode to be applied to the image data, using results of performing the first compression mode and the second compression mode.

12. The image data encoding method of claim 11, wherein the image data includes RGB image data, and the down-sampling down-samples the image data by varying positions of G and R or B during sampling.

13. The image data encoding method of claim 11, wherein the first compression mode is more likely to be applied than the second compression mode as a pixel-by-pixel correlation of the image data increases.

14. The image data encoding method of claim 13, wherein the compressing based on the second compression mode compresses the pre-processed image data based on the second compression mode which is any one of a PCM-based compression mode and a binary-based compression mode.

15. The image data encoding method of claim 11, wherein the selecting selects a compression mode that has a smaller error value or has a smaller error value, based on the results of the first compression mode and the second compression mode.

16. An image data decoding method, comprising:
determining a decompression mode with respect to compressed image data;
decompressing the image data based on a first decompression mode, when the first decompression mode is determined as the decompression mode;
up-sampling, by way of a processor, the image data decompressed based on the first decompression mode; and
decompressing the image data based on a second decompression mode, when the second decompression mode is determined as the decompression mode.

17. The image data decoding method of claim 16, wherein the first decompression mode is more likely to be applied than the second decompression mode as a pixel-by-pixel correlation of the image data increases.

18. The image data decoding method of claim 17, wherein the decompressing based on the second decompression mode decompresses the compressed image data based on the second decompression mode, which is any one of a PCM-based decompression mode and a binary-based decompression mode.

19. The image data decoding method of claim 16, wherein the up-sampling up-samples a first color located at a current position using an average value of a first color located around the current position and a correlation between a second color located at the current position of the first color and a second color located around the current position of the first color.

20. A computer-readable recording medium encoded with instructions causing at least one processing device to perform a method comprising:
pre-processing image data for each block;
down-sampling the pre-processed image data;
compressing the down-sampled image data based on a first compression mode;
compressing the pre-processed image data based on a second compression mode; and
selecting a compression mode to be applied to the image data, using results of performing the first compression mode and the second compression mode.
